(19) United States
(12) Patent Application Publication
(10) Pub. No.: US 2010/0057553 A1
(43) Pub. Date: Mar. 4, 2010

(54) System and Method for Performing a Real Time Redemption Transaction by Leveraging a Payment Network

(76) Inventors: Michael Ameiss, O Fallon, MO (US); Scott A. Reynolds, Darien, CT (US); Frederick F. Branca, JR., Patterson, NY (US); Chris Suppa, Katonah, NY (US); Daniel Scott Poswolsky, Plainview, NY (US); Patrick E. Regan, Newark, DE (US)

Correspondence Address: BAKER BOTTS L.L.P., 30 ROCKEFELLER PLAZA, 44TH FLOOR, NEW YORK, NY, 10112-4498, US

(21) Appl. No.: 12/554,623

(22) Filed: Sep. 4, 2009

Related U.S. Application Data
(60) Provisional application No. 61/094,224, filed on Sep. 4, 2008.
(60) Provisional application No. 61/096,621, filed on Sep. 12, 2008.

(51) Int. Cl. G06Q 30/00

(52) U.S. Cl. 705/14.32

(57) ABSTRACT

A method and system for performing a redemption transaction by leveraging a payment network provides a way to conduct redemption transaction without requiring changes to merchant or acquirer infrastructure. The cardholder initiates a transaction using a redemption card. An intermediary receives the transaction data, determines whether the loyalty points account associated with the redemption card has sufficient points to cover the transaction, and initiates a secondary payment transaction against a secondary payment account. Alternatively, these functions may be performed by the issuer.

### CROSS REFERENCE TO RELATED APPLICATIONS

This application is based on and claims priority to U.S. Provisional Application Ser. No. 61/094,224 filed Sep. 4, 2008 and U.S. Provisional Application Ser. No. 61/096,621 filed Sep. 12, 2008. Both of these applications are incorporated herein by reference in their entireties for all purposes.

### BACKGROUND OF THE INVENTION

Most customers with payment cards participate in some form of loyalty program that allows participants to accrue points, miles, and similar loyalty currency based on spending and other desired behavior. However, current loyalty programs, including general rewards programs, airline mileage programs, and merchant-specific frequent buyer programs, have many limitations that frustrate customers and work against the loyalty goals of the program.

The ubiquity of loyalty programs has led to their dilution. A customer is able to obtain a payment card featuring a loyalty program from one of several issuers whose loyalty programs are often quite similar. As such, the loyalty program is not as significant a differentiator as in the past. In addition, because all the cards a cardholder possesses are likely to include a loyalty program, this feature may no longer drive the decision on which card to use when paying for a particular purchase. Increasing the attractiveness and competitiveness of the loyalty program is a key priority of many issuers.

Issuers and merchants have incentives to provide attractive programs for spending loyalty points. Issuers and some large merchants who sponsor and host extensive, complex rewards programs for their customers need to carry the aggregate of unused but active loyalty points as a liability on their balance sheet. These parties have become increasingly sensitive towards this liability and are looking for new ways to enable their customers to redeem their points. There have been some attempts by merchants and acquirers to connect an individual's loyalty program to a payment vehicle to encourage points redemptions; however, these programs generally require substantial infrastructure changes to multiple parties in the payment network. Additionally, these solutions generally do not enable real-time authorization and settlement of the transaction being attempted using the reward/loyalty point balance.

Additionally, some attempts to differentiate customer loyalty products in order to optimize their value have focused on cash back reward programs, where a cardholder receives either cash or gift certificates for using their loyalty program card. However, these programs have their limitations as well. Other attempts have allowed the conversion of earned points into cash. However, in lieu of real-time capabilities, they generally employ a rebate or other retroactive process that requires a long wait period for the customer to receive the funds.

### SUMMARY OF THE INVENTION

In one aspect, the present invention provides a method for authorizing a redemption transaction in real-time, the method comprising: receiving, from an acquirer financial message generation system, a financial transaction message comprising transaction data, the transaction data comprising an account identifier and a transaction amount, detecting that the account identifier is associated with a redemption card, communicating a redemption transaction message to a rewards system processor, identifying by the rewards system processor at least one loyalty account associated with the redemption card, determining a loyalty points equivalent to the transaction amount, querying a database associated with the at least one loyalty points account to determine if the balance of loyalty points associated with the account is at least as large as the loyalty points equivalent and, if the result is that sufficient points are present, deducting the loyalty points equivalent from the at least one loyalty points account, determining a secondary payment mechanism to settle the redemption transaction, initiating a secondary payment transaction against the secondary payment mechanism in an amount sufficient to satisfy the transaction amount, receiving a secondary response to initiating the second payment transaction, and transmitting a financial transaction response message to said financial transaction message indicating that the financial transaction is authorized, in response to receiving the secondary response.

In another aspect the present invention provides a points bank apparatus for authorizing a redemption transaction in real time, the apparatus comprising: a rewards system processor, a receiver configured to receive, from an acquirer financial message generation system, a financial transaction message comprising transaction data, the transaction data comprising an account identifier and a transaction amount, the receiver further configured to receive a secondary response to the initiation of a secondary payment transaction, a routing unit, coupled to the receiver and to the rewards system processor, configured to detect that the account identifier is associated with a redemption card and to communicate a redemption transaction message to the rewards system processor, a database, coupled to the rewards system processor, associated with at least one loyalty points account associated with the redemption card, and a transmitter, coupled to the routing unit, configured to transmit a financial transaction response message to the financial transaction message indicating that the financial transaction is authorized in response to receiving the secondary response, wherein the rewards system processor is configured to identify the at least one loyalty points account associated with the redemption card, determine a loyalty points equivalent to the transaction amount, query the database to determine if the balance of loyalty points associated with the account is at least as large as the loyalty points equivalent and, if the result is that sufficient points are present, deduct the loyalty points equivalent from the at least one loyalty points account, determine a secondary payment mechanism to settle the redemption transaction, and initiate the second payment transaction against the secondary payment mechanism in an amount sufficient to satisfy the transaction amount.

### BRIEF DESCRIPTION OF THE DRAWINGS

FIG. 1 illustrates an exemplary embodiment of the stages of the redemption card program from the establishment of the loyalty program until the cardholder uses the redemption card as part of a redemption transaction.

FIG. 2 illustrates an exemplary embodiment of the establishment of a redemption card program.

FIG. 3 shows an exemplary embodiment of value per point rates.

FIG. 4 illustrates an exemplary embodiment of the process by which the customer registers for the redemption card program.

FIG. 5 illustrates an exemplary embodiment of the process by which the points bank sets up a loyalty points account for use in a redemption transaction program.

FIG. 6 illustrates an exemplary embodiment of the redemption transaction process.

FIG. 7 illustrates an exemplary embodiment of the redemption transaction process in which the points bank is separate from the redemption card issuer.

FIG. 8 illustrates an exemplary embodiment of a portion of the redemption transaction process, specifically relating to the portion of the redemption process in which the points bank selects a secondary payment account or declines the transaction.

FIG. 9 illustrates an exemplary embodiment of the process by which the points bank determines whether the loyalty points account has a sufficient points balance to cover the transaction.

FIG. 10 illustrates an exemplary embodiment of a portion of the redemption transaction process.

FIG. 11 illustrates an exemplary embodiment of the redemption transaction process in which the redemption card issuer also provides points bank services.

FIG. 12 illustrates an exemplary embodiment of a portion of the redemption transaction process including a split tender option.

FIG. 13 illustrates an exemplary embodiment of the balance inquiry process.

FIG. 14 illustrates an exemplary embodiment of the balance inquiry screen.

FIG. 15 illustrates an exemplary embodiment of the return process.

### DETAILED DESCRIPTION OF THE DRAWINGS

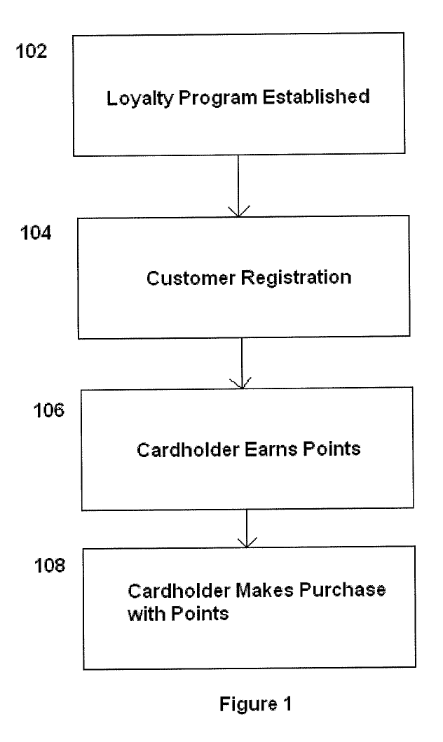

FIG. 1 illustrates an exemplary embodiment of the redemption card program from the creation of a loyalty program until the cardholder makes a purchase using a redemption card. The individual steps of this process will be described in greater detail herein. First, the loyalty program is established at 102. Then, the customer signs up for the loyalty program at 104. The cardholder earns points at 106 and uses those points to fund redemption transactions at 108.

### Establishment of Loyalty Program

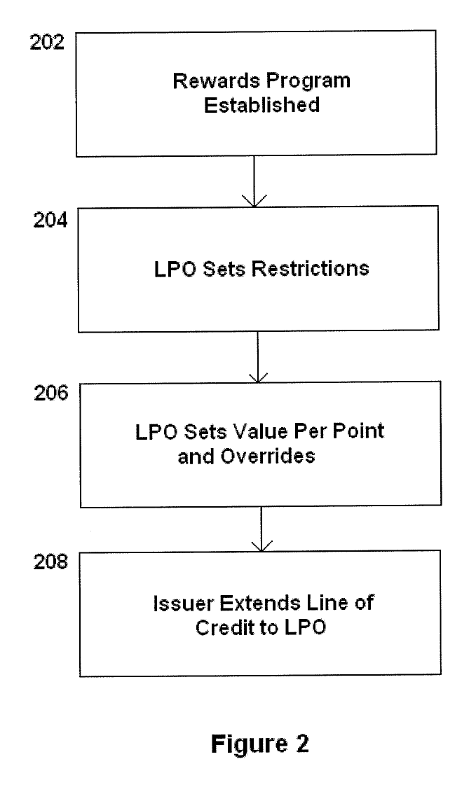

Referring to FIG. 2, a loyalty program is established in 202. The loyalty program may be established with an agreement between three entities: a loyalty program operator (LPO), an issuer, and a Points Bank. While the establishment of a loyalty program will be described with reference to FIG. 2, the way in which the loyalty program is established may vary without departing from the scope of the invention and a person skilled in the art will recognize that a variety of methods known in the art may be employed to establish the rewards program.

The LPO may be the entity in charge of the loyalty program. The LPO may set the general rules for the loyalty program. The LPO may also decide how and at what rate loyalty points are earned and redeemed. The LPO may also be financially responsible for the redemption of the loyalty points. The LPO may be a merchant, a retail establishment, a retail group, a bank or other financial institution, or any other entity.

If the LPO is not a financial institution, it may partner with an issuer of a redemption card. The LPO may also create a points earning card with an issuer. The points earning card may be, for example, a co-branded card product. The issuer may issue both the points earning card and the redemption card. An issuer may be any entity, such as a financial institution, which issues payment devices such as credit or debit cards. The issuer is responsible for settling with the acquiring bank for any transactions made against the redemption card.

The points bank may refer to a points bank operator, which is the entity that provides points bank services. The points bank may also refer to a points bank system or rewards system processor, which is the particular system that provides points bank services. Points bank services may include accounting functions related to the loyalty points account and redemption services such as checking whether a cardholder has sufficient points in a loyalty points account to cover the redemption transaction.

The points bank operator may also include other systems in addition to the rewards system processor. The points bank operator may include a receiver for receiving a financial transaction message from the acquirer, a router for directing the flow of a redemption transaction, a database for storing loyalty points account information such as a points balance, and a transmitter for transmitting a financial transaction response message to the acquirer indicating whether the transaction has been approved or denied. The functions of the receiver and transmitter may be combined into a single transceiver. If the points bank operator is also the issuer, the points bank operator may include financial processing systems. The points bank operator may be the LPO, the issuer, or any third party such as MasterCard or another payment network.

Referring again to FIG. 2, the LPO sets restrictions, rules, and controls on the use of points in 204. The terms “restrictions,” “rules,” and “controls” are used interchangeably herein to describe any limitations placed on the use of points, if appropriate in the context. Restrictions may include transaction amount restrictions, periodic redemption limits, merchant-based controls, and minimum balance restrictions.

Transaction amount restrictions, which are also called ticket size restrictions herein, may include any restrictions on redemption transactions based on the transaction amount. The LPO may specify that a redemption transaction is not to be allowed if the transaction amount is lower than a specified low-limit. The LPO may also specify that a redemption transaction is not to be allowed if the transaction amount is higher than a specified high-limit. These limits may vary based on merchant category or transaction type (i.e. merchant category code, card not present, moto, etc.)

Periodic redemption limits may include any temporal restrictions on redemption transactions. The LPO may specify that a redemption transaction is not to be allowed if a specified number of redemption transactions have already occurred in a specified period. The LPO may also specify that a redemption transaction is not to be allowed if a specified amount of points have already been redeemed in a specified period. The redemption limits may be daily, weekly, monthly, yearly, or any other period set by the LPO. Multiple periodic redemption limits may be set simultaneously. For example, a particular redemption transaction may need to pass both a weekly redemption limit and a yearly redemption limit in order for the redemption transaction to be authorized against the loyalty points account.

Merchant-based controls may include any restrictions on redemption transactions based on merchant identification information. Merchant identification information includes merchant category classifications such as MCCs. Merchant identification information also includes specific merchant information, such as the identity of a company (Z Corp.) or a single merchant location (the Z Corp. store in Purchase, N.Y.). The LPO may choose to block redemption transactions with specified merchants or merchant categories based on merchant identification information. Alternatively, the LPO may choose to allow redemption transactions only with specified merchants or merchant categories based on merchant identification information.

Minimum balance restrictions may include any restrictions on redemption transactions based on a requirement that the loyalty points account reach or maintain a certain minimum balance. For example, the LPO may indicate that a loyalty points account must have a certain minimum balance before a redemption transaction is allowed. The LPO may also specify that a redemption transaction should not be allowed if the redemption transaction will cause the updated points balance (i.e., the points balance of the loyalty points account after the points needed to cover the redemption transaction are redeemed) to drop below a specified minimum points balance threshold. The LPO may also require a certain minimum credit amount remaining in an associated alternate funding account, such as when a redemption purchase also requires a nominal payment from the alternate funding account.

The LPO may set additional rules, restrictions, and controls on the loyalty program. For example, the LPO may not allow more than a specified number of consecutive redemption transaction to be funded by the alternate funding account. The LPO may also use rules, restrictions, or controls to disable an account. For example, consider a loyalty program associated with a large hotel chain. If a cardholder refuses to pay his/her bill, the LPO may decide to deactivate or freeze the cardholder's loyalty points account until the bill is paid.

The restrictions may be set at multiple levels of applicability. A restriction set at the account level will apply only to the loyalty points account specified by the LPO. A restriction set at the account range level will apply to any loyalty points account in the account range specified by the LPO. The account range level may be specified by a portion of the bank identification number (BIN). A restriction set at the merchant category code (MCC) level will apply to any redemption transaction with a merchant in the merchant category specified by the MCC. Similar (non-MCC) merchant category classifications may also be used. A restriction set at the specific merchant level will apply to any redemption transaction with a specific merchant identified by the LPO. A specific merchant may include a single company or a specific merchant location. A restriction set at the loyalty program level will apply to any redemption transaction for a participating cardholder.

Referring again to FIG. 2, the LPO next sets the value per point (VPP) levels. The LPO may set base VPP levels and VPP overrides. The base VPP level sets the VPP rate at which points will be redeemed for every transaction not subject to a VPP override. The base VPP level may be a flat rate for all transactions. For example, the LPO may set the base VPP level at $0.01 per point. The base VPP level may also be set as a variable rate. For example, the base VPP levels may be chosen with reference to the ticket size. While the LPO may have considerable freedom in choosing base VPP levels, the chosen VPP levels must establish a base VPP level for every possible transaction.

The LPO may also specify overrides to the base VPP levels. Overrides may include any changes from base VPP levels. While VPP overrides generally increase the VPP over the base VPP, the overrides may also decrease the VPP as compared to the base VPP. For example, one VPP override may reduce the VPP for cash withdrawals at an ATM. VPP overrides may defined with reference to merchant identification information, ticket size, cardholder information, cardholder behavioral information (such as purchase history or volume history), cardholder segmentation information (age, gender, location, income level), or any other information specified by the LPO.

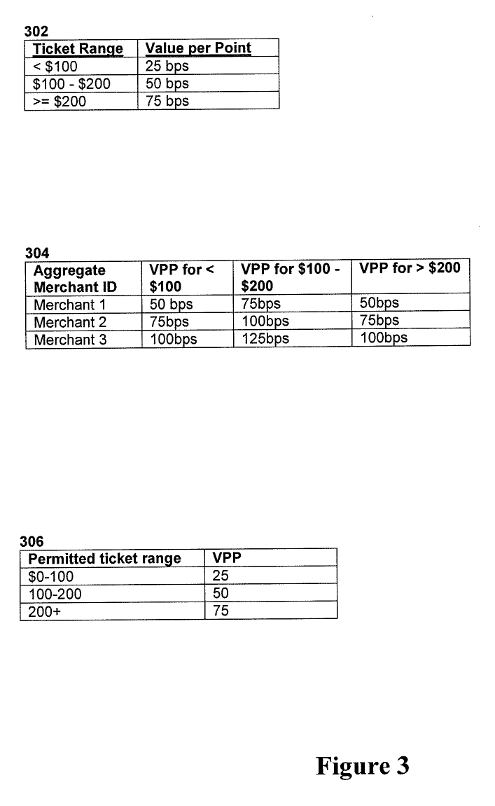

VPP levels are further explained with reference to FIG. 3, which contains three tables for defining VPP levels. The VPPs are defined in terms of basis points (bps) in this example. Any cash value or cash value equivalent may be used to define the VPP levels. The tables in FIG. 3 are presented for illustrative purposes only. As will be apparent to persons skilled in the art, the VPP levels and conversion ratios can be set by the LPO, issuer, or other participants based on any criteria that best serves the goals of the program.

Table 302 defines VPP levels based on ticket size. Table 302 may be a VPP override level, with a base VPP level separately defined. Alternatively, table 302 may be a base VPP level. Importantly, every possible transaction will have a ticket size in one of the defined ranges. Assuming that table 302 is a base VPP level, table 302 will define the VPP level for a redemption transaction if no override is selected. For example, points may be redeemed at a rate of 25 bps if the transaction has a ticket size under $100.

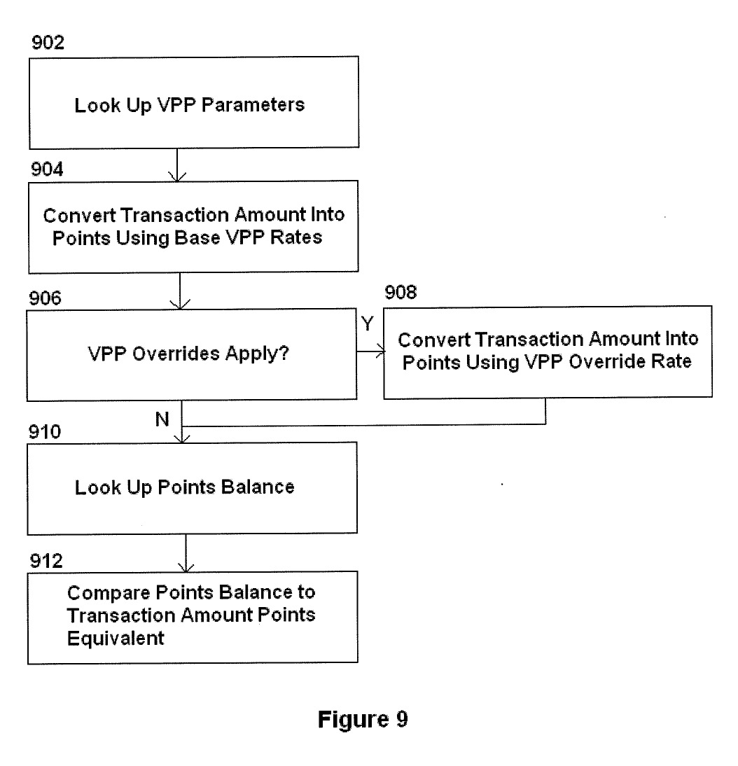

Table 304 defines VPP levels based on both ticket size and merchant identification information. Table 304 cannot define a base VPP level because no VPP rate is defined for merchants other than Merchants 1, 2, and 3. Thus, for example, no VPP rate could be assigned to a transaction with Merchant 4 (not shown). A particular VPP override level will be selected for use as the VPP level for a redemption transaction if the conditions apply (here, that the merchant is one of the identified merchants and that the ticket size is within one of the identified ranges) and no other applicable VPP override will result in a higher VPP rate for the particular redemption transaction. Alternatively, the LPO may specify that a particular VPP override always applies if the conditions are met. Assuming the VPP override level of Table 304 applies to a redemption transaction, points will be redeemed at a rate of 100 bps per point for a redemption transaction with Merchant 2 having a ticket size of between $100 and $200. An example of a redemption transaction points conversion is provided later, in connection with FIG. 9. Table 306 of FIG. 3 shows the VPP levels available at an ATM. While the LPO may choose to set VPP levels for cash withdrawals, the LPO may also choose to exclude ATM cash withdrawals. The LPO may accomplish this by setting a rule which does not allow redemption transactions with merchants having a merchant category classification assigned to ATMs.

The VPP levels and the rules and restrictions may be set by the LPO in a number of ways. The LPO may transmit the information electronically to the issuer, who may then transmit the information electronically to the points bank. The LPO or issuer may also be able to specify this information through a web interface. The LPO or issuer may also change the settings after the initial rules and restrictions or VPP levels have been set. For example, restrictions set at the account level are likely to be set when the account is created or assigned to a participating cardholder. In addition, the LPO may choose to change any of the restrictions after they have initially been set.

In addition to rules, restrictions, controls, and VPP levels, the LPO may also configure additional settings. For example, the LPO may configure a way for points to be activated/deactivated. Generally, points will be activated when they are earned. Additionally, the points will have a LPO-provided expiration date and will expire if they are not used within a pre-determined period, such as 6 months. A first in-first out (FIFO) processing system might be used to redeem the points, so that the oldest points (i.e., the points with the earliest expiration date) will be used to cover a redemption transaction before the newest points. The LPO may also specify whether an alternate funding source may be used if the amount of points is insufficient to fund a transaction, and whether SMS or other messaging is enabled.

Returning to FIG. 2, the issuer may extend a line of credit to the LPO in 208. The line of credit may be associated with a payment mechanism, such as by the issuance of a corporate card with a credit line. The corporate card may have large transaction frequency limits. The line of credit may be used to fund redemption transactions. An acquiring bank must receive funds from the issuer in a credit or debit transaction. However, a loyalty points account cannot fund this transaction because loyalty points have no inherent value outside of the loyalty program. The line of credit may be used to fund the issuer's payment to the acquirer. The issuer settles with the acquirer and charges the LPO through the LPO's corporate card. The issuer later reconciles with the LPO through the LPO's corporate card account by receiving payment from the LPO on the credit balance of the account. In other embodiments, the LPO may settle with the issuer through a debit account linked to a corporate card account or through any other funding account such as ACH, or other funding mechanisms. The account through which the LPO settles with the issuer is called the loyalty program funding account. While the authorization process is described using a payment card account associated with the corporate card, it should be understood that the points bank and/or issuer may identify any account as the loyalty program funding account without departing from the scope of the invention.

Clearing and settlement may occur by any of the techniques well known in the art, including through the MasterCard Global Clearing Management System (GCMS). The clearing system as described herein may be the GCMS, but it also may be any other system capable of performing clearing functions. Clearing generally occurs periodically (e.g., once a day), but may occur at any periodic or non-periodic interval. The merchant's bank (the acquirer) sends purchase information to the clearing system. This may be done individually or in combination with purchase information regarding other transactions. The purchase information may include the amount due to the acquirer. The clearing system then identifies an issuer associated with the payment mechanism used to fund the transaction (e.g., the loyalty program funding account used to fund the redemption transaction). The clearing system calculates the amount that needs to be transferred between the issuer and the acquirer to reconcile the transaction in combination with any other transaction using a payment mechanism associated with the same issuer. The clearing system may also validate the purchase information. The clearing system then sends a message to the issuer. This message may indicate the amount that needs to be transferred to the acquirer to reconcile the transactions, the purchase information, and any other information regarding the reconciliation. The acquirer and the issuer will later settle the transaction. The actual exchange of funds takes place between a clearing bank and a settlement bank. Settlement may occur in U.S. dollars or in any other currency acceptable by both parties to the settlement transaction.

### Cardholder Registration

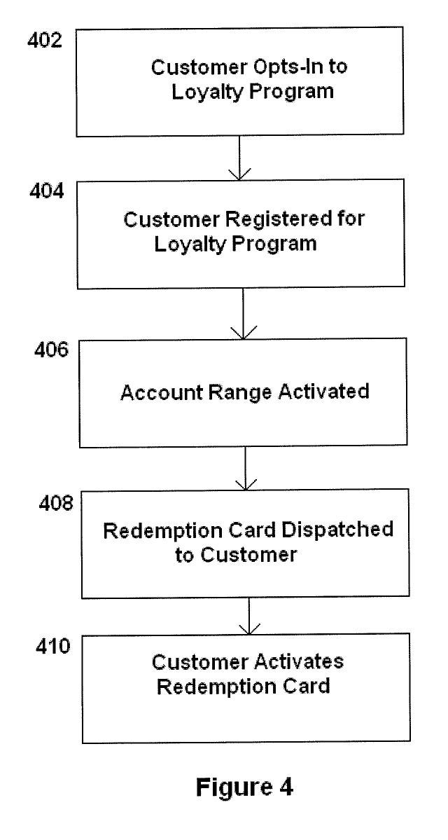

In one embodiment of the techniques of the present invention, a cardholder opts into the redemption program. While the cardholder does not actually have a redemption card at this time, he will nonetheless be referred to as the cardholder or account-holder. Referring to FIG. 4, an exemplary embodiment of the cardholder registration process is shown. The cardholder opts into the redemption or loyalty program at 402. The cardholder may opt-in through a wide range of channels, including online, over the phone through an 800 number, a voice response unit system (VRU) or an interactive voice response (IVR) system, by mail, or in person at a LPO or issuer location. Cardholders may opt-in to the redemption card program at the same time they enroll in the loyalty program. Alternatively, customers may already be enrolled in the loyalty program. For example, a loyalty program in which points may be spent only for a limited number of goods or services may add a redemption card program. Loyalty program refers to any loyalty program, which may include a redemption card program. Redemption card program refers to a loyalty program utilizing a redemption card as described herein to redeem or otherwise spend previously-accrued loyalty points.

The cardholder may be required to provide certain registration data to the merchant, LPO and/or issuer. This registration data may include personal identification information such as the cardholder's name, address, phone number, or similar information. The registration information may also include loyalty points account information for cardholders who are previously enrolled in the linked loyalty program. Alternatively, the merchant and/or issuer may have all necessary information for cardholders previously enrolled in the loyalty program. The cardholder may also be required or choose to provide additional information. For example, the cardholder may choose to receive messages from the merchant, issuer, or points bank for various reasons. For example, the cardholder may choose to receive notification of predetermined events or promotional and/or marketing messages. If the cardholder chooses to receive such messages, the cardholder can provide a mobile phone number and specify the predetermined events which will result in messages.

The cardholder may further be required or choose to provide cardholder-supplied controls, rules, or restrictions for redemption transactions. For instance, using a web interface, the cardholder may, prior to conducting a transaction at the point of sale, specify particular merchants, merchant categories, transaction amounts, or other transaction characteristics for transactions that should be applied to the cardholder's loyalty points account, or that should not be applied to a cardholder's loyalty points account. For example, the cardholder may request that payment card A be used to fund gas and food purchases, but payment card B be used to fund all other purchases. Processing of the transaction would then proceed accordingly. In this manner, a cardholder is able to use a single payment card at all merchants, but have the individual transaction settled using different payment mechanisms, including loyalty point accounts, depending on the transaction details, while requiring no modifications to the merchant/acquirer infrastructure.

The cardholder is registered with the points bank at 404. This may involve linking a cardholder's loyalty points account to the cardholder's redemption card, so redemption transactions initiated by the cardholder using the redemption card can be “funded” by the points in the cardholder's loyalty points account. The cardholder may be registered with the points bank through the issuer. The issuer receives cardholder registration information and assigns a new redemption card number to the cardholder. The redemption card number may be related to the co-branded credit card or other points earning card through a look-up table or algorithmically. A password-protected registration request may be sent to the points bank from the issuer. Alternatively, the issuer may provide points bank services internally. The issuer may register cardholders with the points bank individually or in a batch process.

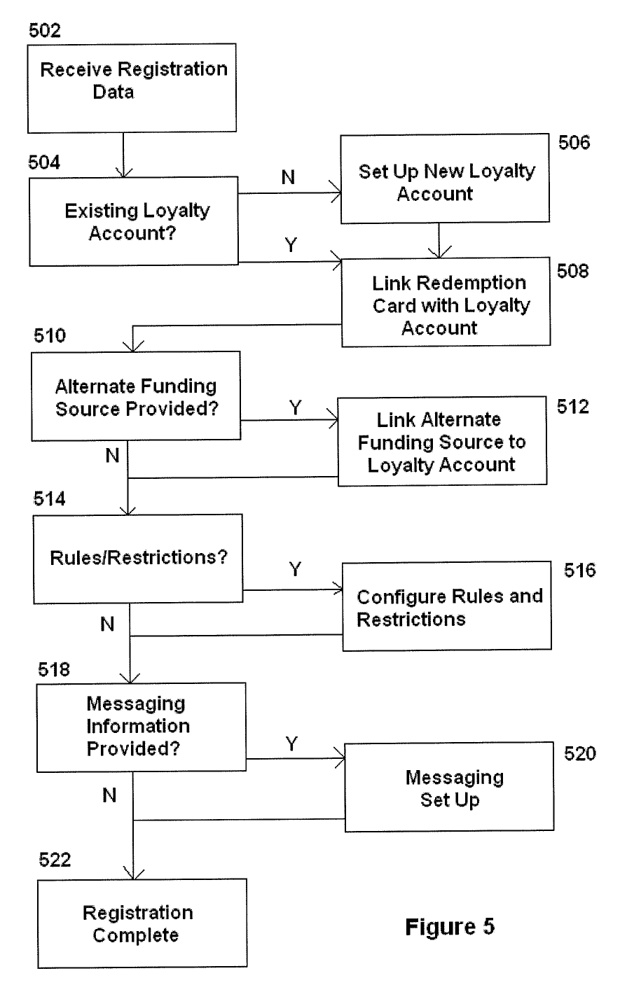

FIG. 5 illustrates an exemplary embodiment of the process by which the cardholder is registered with the points bank. The points bank receives registration data from the issuer in 502. The registration data may include the cardholder registration information and the redemption card number.

After the points bank has received cardholder registration data, the points bank determines whether the cardholder has an existing loyalty points account in 504. If the cardholder does not have a pre-existing loyalty points account, the points bank may create a loyalty points account for the cardholder in the points bank in 506. The loyalty points account may then be linked with the redemption card at 508. More specifically, the loyalty points account may be linked with a redemption card number specified by the issuer. The redemption card number may be a PAN which is or will be located on the front of the redemption card and/or on other computer readable media on the card, such as an IC chip or magnetic stripe. If the cardholder already has an existing loyalty points account, the points bank may link a redemption card number specified by the issuer with the existing loyalty points account in 508. Alternatively, the LPO may specify that a new account should be created even if there is a pre-existing account to separate the new loyalty program from the old loyalty program. If this is the case, the LPO may also set rules for transferring the balance of the old loyalty points account to the loyalty points account linked with the redemption card.

The points bank next determines whether an alternate funding source has been provided by the cardholder in 510. This step may be skipped if the LPO has specified that the redemption card may not be linked to an alternate funding source. The alternate funding source may be the points earning card, a credit card, a debit card, a home equity line of credit, or any other funding account. If the cardholder has provided an alternate funding source, the points bank links the alternate funding source to the loyalty points account and/or the redemption card in 512. Alternatively, the LPO may indicate that the co-branded card must be the alternate funding source.

The points bank next determines whether there are any rules or restrictions which need to be configured for the cardholder's loyalty points account in 514. This may include any of the rules, restrictions, and controls specified by the LPO during the establishment of the loyalty program. This may also include any of the rules or restrictions specified by the customer during registration. If rules and restrictions have been established for the cardholder's loyalty points account, the points bank configures the account to conform with these rules and/or restrictions at 516.

Additional account features may also be set up during registration. For example, if the LPO allows SMS messaging for account alerts and the cardholder has registered for this service, the points bank may set up these features. The points bank determines whether SMS and/or e-mail messaging information has been provided by the cardholder in 518. Messaging information may include whether the cardholder has chosen to receive the alerts, the predetermined events which will trigger notification, and a phone number or other address where the alerts are to be sent. If the cardholder has provided messaging information, the points bank sets up the messaging services in 520. Once all the account configurations have been set up, the points bank completes the registration at 522.

Referring again to FIG. 4, the account range may need to be activated. The issuer may designate a specific account range exclusively as a redemption portfolio. If there are no available account numbers in an activated redemption portfolio, the issuer may request that a new account range be activated in the points bank. The account range may be designated by a subset of the BIN. For example, the account range may include all accounts for which the first 6 numbers of the BIN are 123456. This account range information may be used for routing purposes.

Next, the redemption card is dispatched to the cardholder in 408. The redemption card may be sent directly to the cardholder, or the cardholder may be required to pick up the redemption card at a LPO or issuer location. The redemption card may include the cardholder's name and PAN or other redemption card identifier on the face of the card. The redemption card may also include an issuer's name and/or logo, a LPO's name and/or logo, and security features such as a hologram. The redemption card may include a magstripe or an IC chip which may communicate using a contact pad, or contactlessly. The redemption card may include a card with at least one magstripe, a contactless chip or smart card, or a pay-pass-type device. However, the redemption card is not limited to a “card” and may include any payment device, including mobile phones, smart phones, or any object containing a magstripe or a chip interface. A person of ordinary skill in the art will recognize that the form of the redemption card may vary greatly.

While the redemption card may be a new card, the redemption card may also be the original loyalty program card, wherein a cardholder may use the same card to earn and burn (accumulate and redeem) loyalty points. In such a one-card solution, the cardholder may specify in advance when the redemption card features should be used, as previously described. Alternatively, the cardholder may be prompted at the point of sale to indicate whether the redemption card features should be used. In another embodiment, the card may have two magstripes, and the cardholder determines whether to use the redemption card features by swiping the appropriate magstripe.

Finally, the customer may be required to activate the redemption card in 410. The card may have been originally set up with $0 limits as a security feature. The card may not be used in connection with a redemption transaction until the card is activated, at which time the limits are adjusted. The cardholder may activate the redemption card through a number of different channels, including online, phone, and in person.

However, the cardholder may use the points balance of a loyalty points account before the card is activated. A virtual card account number (VCN) may be generated by the issuer of the redemption card, or by the points bank. The cardholder may log on to a web interface configured to generate a VCN. The cardholder enters transaction parameters for a selected transaction. The transaction parameters may include merchant information for a transaction. Generally, the merchant information will identify a website where the cardholder wishes to shop. The transaction parameters may include a dollar amount instead of, or in addition to a merchant identifier. The dollar amount may refer to the price for a particular item, or it may be a general limit on the amount that can be spent using that VCN. Other information may also be entered by the cardholder. The issuer generates a VCN such as a virtual PAN (VPAN) and links the VCN with the cardholder's loyalty points account. During authorization of a transaction, if the points bank receives the VCN, the points bank will check that the transaction parameters are met for the requested redemption transaction. If all of the transaction parameters are not met, the authorization request will be denied. If all of the transaction parameters are met, the requested redemption transaction will be processed as a regular redemption transaction as described herein. A VCN may also be used after the cardholder has received and activated the redemption card.

### Earning Points

The method of earning points as part of a loyalty program is well-known and the art and does not require explanation here. In some loyalty programs, points are earned based on transaction with a particular merchant or group of merchants such as a purchase or use of goods or services. In other loyalty programs, points are earned based on the use of a particular credit or debit card, regardless of where the card is used. Points may be earned as a percentage of a qualifying transaction or a lump sum if certain criteria are met for the transaction.

The term “points” as used herein is not limited to units called points. “Points” may be airline miles, minutes, or any loyalty currency or other unit that represents an accumulation of value. However, points are not intended to mean legal tender. A person skilled in the art will recognize that a large range of loyalty currency units may be used without departing from the scope of the invention.

Generally (although not required), the redemption card issuer will also be the points earning card issuer. The issuer may send a points earned message to the points bank when points are earned by the cardholder. The points earned message may indicate the number of points earned as well as information identifying the loyalty points account. Generally, the points earning card PAN will be linked to the loyalty points account, so the points earned message may include this information. The points bank may then add the earned points to the cardholder's loyalty points account at an appropriate time. For instance, points can be added as soon as a points-earning transaction occurs, or they may be added later, such as after an account-holder pays the issuer for the transaction. Other techniques for determining when to credit the loyalty points to an account will be apparent to persons skilled in the art.

While the process of earning points has been described in connection with the points earning card, cardholders may also be able to earn points on transactions conducted with a redemption card. A cardholder may earn a certain amount of points based on the number of points used to fund the transaction or the transaction amount of the transaction. The ratio of points earned on redemption transactions may vary and may be different than the points earned on transactions with the points earning card. For example, points earned on transactions using the redemption card may be half the points earned on the same transaction if it is conducted using the points earning card.

### Using Points

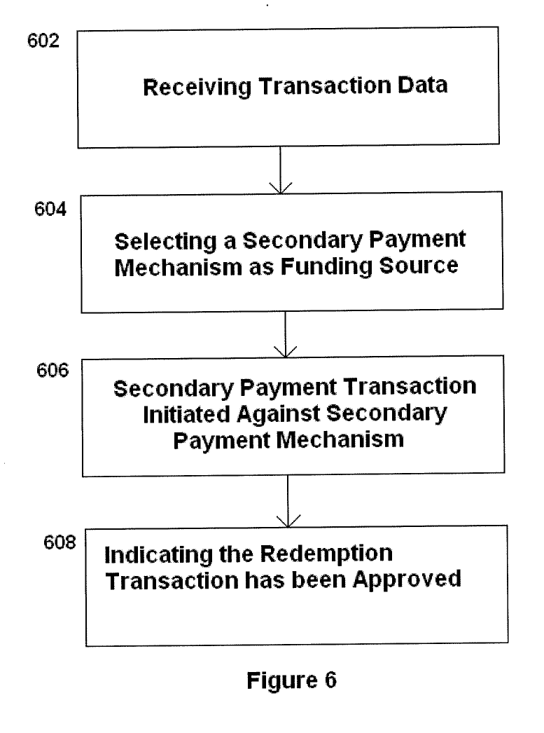

Once the cardholder has accumulated sufficient points, the cardholder may use the redemption card to pay for goods and services with the accumulated points. The general flow of a redemption transaction at a points bank in accordance with the present invention is shown in FIG. 6. First, the points bank receives transaction data in 602. The transaction data generally includes at least the transaction amount and an account identifier. The transaction amount is useful because the points bank and/or issuer can compare it against the available funds in the loyalty points account and/or a secondary payment account in order to authorize the transaction.

The account identifier may be any information that identifies the loyalty points account associated with the redemption card. For example, the account identifier may be the redemption card number, the loyalty points account number, or a VCN associated with the loyalty points account. The account identifier is useful to allow the system to locate a loyalty points account associated with the redemption card.

Next, the points bank selects a secondary payment mechanism as a funding source for the redemption transaction at 604. The secondary payment mechanism may be a secondary payment account. The secondary payment account may be any account which is not the loyalty points account and which is capable of funding the transaction. For example, the secondary account may be a payment card account such as the LPO credit or debit account associated with the LPO's corporate card or the credit or debit account associated with a co-branded points earning card. The secondary payment account may also be any other financial account, such as a line of credit. The secondary account may be another loyalty points account, assuming that second loyalty points account is further linked to an account which is capable of funding the transaction. The secondary payment account is selected to actually fund the transaction. The loyalty points account contains only points. However, funds must be transferred to the acquirer to complete the transaction. Therefore, a secondary payment account or other payment mechanism must be chosen or identified at or near the time of the redemption transaction in order to settle with the acquirer.

A secondary payment account may be selected in a variety of ways. Generally speaking, it may include any method by which the points bank indicates that the secondary payment account should be used as the funding account instead of the loyalty points account. This may include re-mapping the PAN data element in the financial transaction message by substituting the secondary account identifier for the loyalty points account identifier. It may also include generating a new message for transmission over an alternative payment network, such as an ACH or electronic funds transfer system, where the new message identifies the secondary payment source, rather than the redemption card number, in order to effect a financial settlement in real-time or near real-time. Importantly, this remapping or secondary account selection is performed by the intermediary rewards system processor or another system located at the points bank, and does not require modification to the merchant/acquirer acceptance infrastructure. Further, unless the issuer acts as the intermediary, techniques herein require little to no alteration to the issuer's infrastructure.

In 606, a secondary payment transaction is initiated against the secondary payment mechanism in an amount sufficient to satisfy the transaction amount. This may consist of the points bank deducting the transaction amount from the secondary payment account. For example, the points bank may debit the transaction amount from a debit account used as the secondary payment account, or it may post the transaction amount against a credit account used as the secondary payment amount. Note that the amount charged to the secondary account may not match the amount of the redemption transaction. For instance, a premium or other service fees may be applied to the transaction amount before settlement, as will be understood by persons skilled in the art. The initiation of the secondary payment transaction may also consist of sending an authorization request to the issuer requesting authorization of the transaction and specifying the secondary payment account as the funding account. The issuer will then process the request in the regular manner, as though it was an authorization request from the acquirer wherein a payment device associated with that secondary account had been presented to the merchant.

Finally, assuming the secondary payment account has sufficient funds to settle the transaction, the points bank indicates that the redemption has been approved in 608.

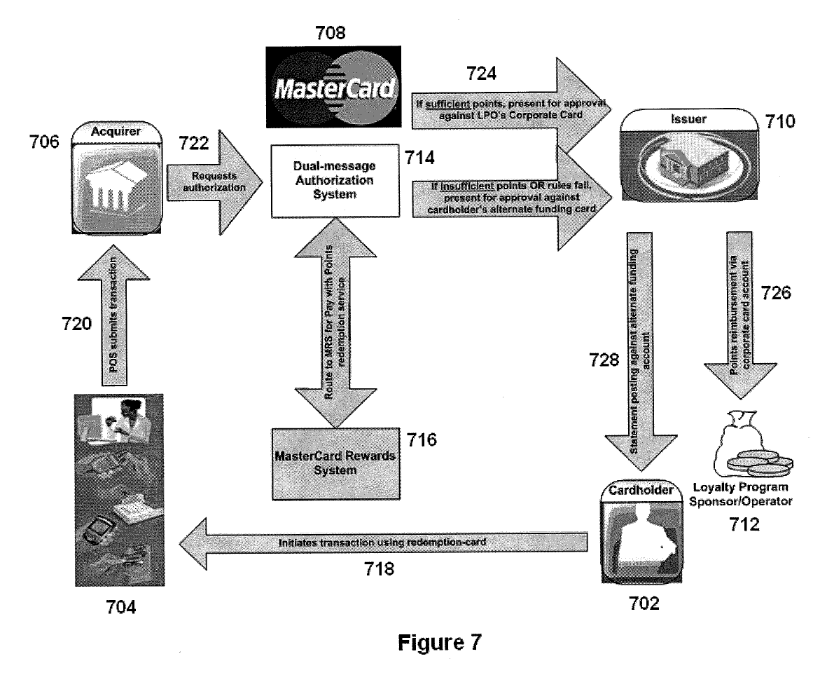

FIG. 7 illustrates an exemplary embodiment of the redemption process. FIG. 7 shows a redemption process involving a cardholder 702, a merchant 704, an acquirer 706, a points bank, 708 (in this case, MasterCard), an issuer 710, and a LPO 712.

The points bank 708 is a points bank operator which, in this embodiment, includes the authorization system 714 and the rewards system 716. The authorization system 714 communicates with the acquirer 706, the issuer 710, and the rewards system 716. Authorization system 714 may be the network for a credit card company such as the MasterCard Banknet network or MasterCard Debit Switch. The rewards system 716 provides the points bank services and includes a rewards system processor. While the points bank may be configured in the manner described, a person of ordinary skill in the art will recognize that the points bank may be configured in other ways.

The cardholder 702 initiates a transaction with a merchant 704 using the redemption card at 718. The cardholder 702 may initiate the transaction by presenting the redemption card as a mode of payment, which may include presenting the redemption card to the merchant 704 at a merchant location. The cardholder 702 may also initiate the transaction by typing the card number into an Internet browser in an e-commerce setting. The manner in which the cardholder 702 initiates the transaction may vary without departing from the scope of the invention.

Next, the merchant 704 submits the transaction to the acquirer 706 at 720. The acquirer 706 may be any financial institution which has an account associated with the merchant 704 and which receives payment at that account on the merchant's behalf. In short, the acquirer 706 is the merchant's bank.

The acquirer financial message generation system generates a financial transaction message and sends it to the points bank 708 at 722. The financial transaction message may include cardholder identification information such as the cardholder's redemption card number, merchant identification information such as the merchant category classification and specific merchant information, and transaction information such as the transaction amount.

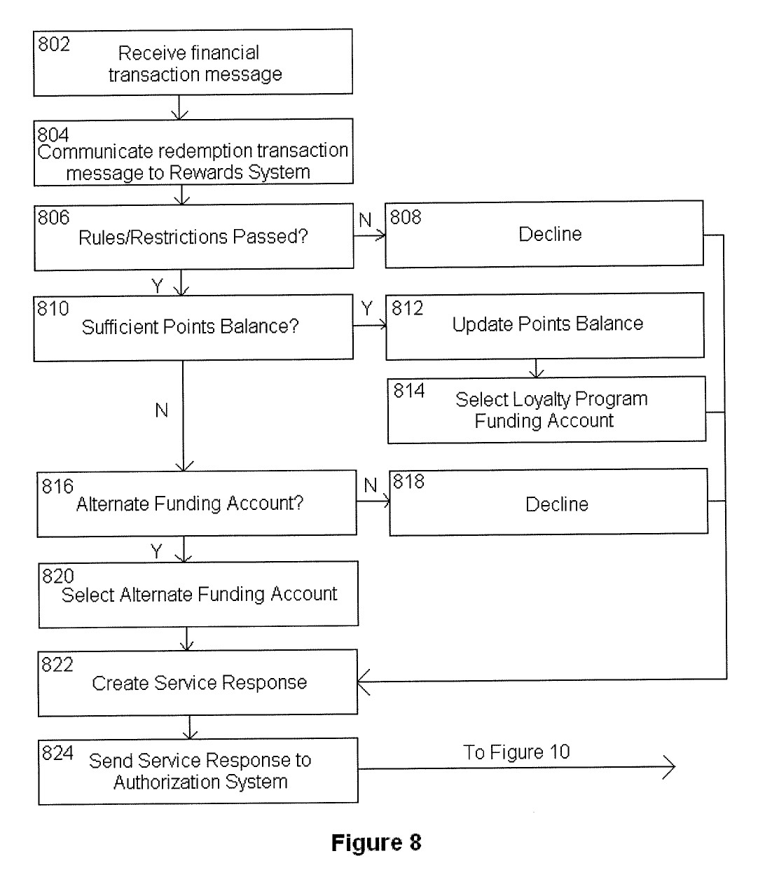

An exemplary embodiment of one portion of the authorization process is illustrated in FIG. 8. The authorization system 714 receives the financial transaction message from the acquirer 706 at 802. The authorization system 714 then determines whether an account identifier included in the financial transaction message is associated with a redemption card. If the system detects that the account identifier is associated with a redemption card (such as by referencing a table of account numbers, BINs, or account ranges that are known to be redemption cards), the authorization system 714 communicates a redemption transaction message to the rewards system 716 at 804. The redemption transaction message received by the rewards system 716 may be the financial transaction message generated by the acquirer 706, or it may be any other request for the rewards system 716 to approve a redemption transaction.

The rewards system 716 first determines whether the requested transaction passes the rules and restrictions established for the loyalty program at 806. These rules and restrictions may include ticket size restrictions, periodic redemption limits, POS merchant based controls, minimum account balance restrictions, and any other type of rule or restriction set by the LPO, issuer, or cardholder. If the request does not pass all rules and restrictions (for example, if the LPO has specified that points may not be redeemed for transactions with the merchant 704), the transaction may be declined at 808, or the transaction may be converted to a traditional payment transaction using a secondary payment mechanism.

As previously described, in some embodiments the cardholder can specify rules for use by the intermediate processor to determine how to treat a transaction performed using the redemption card, and these rules can be utilized during step 806 and/or step 810. If the transaction is a type that the cardholder has specified should not be applied to the loyalty points account, the rewards processor may treat the transaction as one for which the sufficient loyalty points are not available, and/or may route the transaction directly to a secondary payment mechanism, including a secondary payment mechanism previously specified by the cardholder.

If the requested transaction passes all rules and restrictions, the rewards system 716 determines whether the cardholder has sufficient points in the loyalty points account associated with the redemption card to cover the transaction amount at 810. An exemplary embodiment of the process for determining whether the loyalty points account contains sufficient points to cover the redemption transaction is illustrated in FIG. 9. The rewards system 716 looks up VPP parameters at 902. VPP parameters may include base VPP levels and any VPP overrides. The VPP parameters have been set by the LPO 712 and/or the issuer 710. The VPP parameters are used to determine a loyalty points equivalent to the transaction amount. In FIG. 9, the rewards system 716 first converts the transaction amount of the requested transaction into a transaction amount points equivalent using the base VPP values at 904. For example, consider a redemption transaction in which the transaction amount is $100. Referring again to FIG. 3, the VPP for a transaction amount greater than or equal to $100 is 50 bps as seen in Table 302. 50 bps is equivalent to 1 pt per $0.50, so the rewards system 716 would calculate the transaction amount points equivalent (TAPE) as:

$$TAPE = \$100 \times \frac{1 point}{\$0 .50} = 200 points$$

Referring again to FIG. 9, if the rewards system 716 determines that any of the VPP overrides associated with the cardholder's loyalty points account apply to the requested transaction at 906, the rewards system 716 calculates the transaction amount points equivalent using the appropriate VPP override rate. For example, consider the situation in which the merchant 704 is Merchant 2 referenced in Table 304 of FIG. 3. The override VPP rate in Table 304 would apply to the requested transaction with Merchant 2. Assuming that 100 bps is equal to 1 pt per $1, the rewards system 716 would calculate the transaction amount points equivalent as:

$$TAPE = \$100 \times \frac{1 point}{\$1 .00} = 100 points$$

When two or more VPP overrides are applicable, the rewards system 716 may use the override that results in the maximum value for the cardholder or may use another criteria to select the appropriate VPP. The LPO may prioritize certain VPP overrides, such that the prioritized VPP override rate is used even if another VPP override would result in the cardholder receiving a higher VPP rate. For example, the LPO may choose to prioritize an ATM VPP override specifying a lower VPP rate for cash withdrawals at an ATM.

Referring again to FIG. 9, the rewards system 716 looks up the points balance of the loyalty points account associated with the cardholder 702 at 910. This query of the points database may be performed using well-known techniques, such as a web API or other approaches to querying a database. Finally, the rewards system 716 compares the points balance to the transaction amount points equivalent at 912.

While one method of determining a loyalty points equivalent to the transaction amount has been described, those having skill in the art will understand that any method of converting the transaction amount and points balance into a common unit for purposes of comparison may be used. For example, the points balance may be converted into a points balance cash equivalent for comparison with the transaction amount. The points balance and the transaction amount may also be converted into a third unit for purposes of comparison.

Further, while the VPPs and the transaction amount have been described in terms of dollars, they may be based on any currency. The LPO 712 may choose to establish VPPs for a wide range of currencies. The issuer 710 may choose to convert only between points and a single currency, such as a local currency or another currency specified by the issuer. In such a situation, the issuer 710 or points bank 708 may convert between the issuer currency and the merchant currency using an algorithm or conversion rates set by any of the parties to the transaction.

Referring again to FIG. 8, the rewards system determines whether the cardholder's loyalty points account has sufficient points to pay for the transaction at 810. If the cardholder's point balance is greater than the transaction amount point equivalent, the rewards system 716 updates the points balance of the cardholder's loyalty points account to reflect the transaction at 812. The transaction amount points equivalent is subtracted from the points balance to calculate an updated points balance for the cardholder's loyalty points account. The rewards system 716 also selects the loyalty program funding account as the secondary payment account for the transaction at 814. For example, the rewards system may select the LPO's corporate card account by selecting a PAN associated with the LPO's corporate card.

If the cardholder's loyalty points account does not have sufficient points to fund the transaction (i.e., the cardholder's points balance is less than the transaction amount point equivalent), the rewards system 716 determines whether an alternate funding account has been specified by the cardholder 702 at 816. If no alternate funding account has been specified by the cardholder 702, the transaction may be declined at 818. If the cardholder 702 has specified an alternate funding account, the rewards system 716 selects the alternate funding account as the funding account for the requested transaction. The rewards system 716 may also update the usage count and check to make sure the use of the alternate funding account is acceptable based on limits of consecutive usage of the alternate funding account. If the updated usage count is higher than the allowed usage count, the points bank declines the transaction.

Regardless of the outcome of the different authorization tests performed by the rewards system, the rewards system creates a service response at 822. The service response includes information relating to whether the transaction has been authorized or declined. The service response may include information relating to the secondary payment account for an authorized transaction. The service response may also include information such as cardholder identification information including the PAN associated with the redemption card or transaction decline information including the reason the rewards system 716 declined the transaction. For example, for a requested transaction declined at 808 of FIG. 8, the service response may include data fields indicating that the requested transaction is declined and that the transaction did not pass one of the rules or restrictions. The service response may also include data indicating which rule or restriction the transaction did not pass. The service response message may also include points balance information, such as the new points balance if the transaction has been approved, the current points balance if the transaction has been declined, and the cash value of the points balance based on base and maximum VPP rates, if applicable. After the service response is created, the rewards system 716 routes it to the authorization system 714 at 824 and/or to a SMS, or e-mail, or other messaging gateway (not shown).

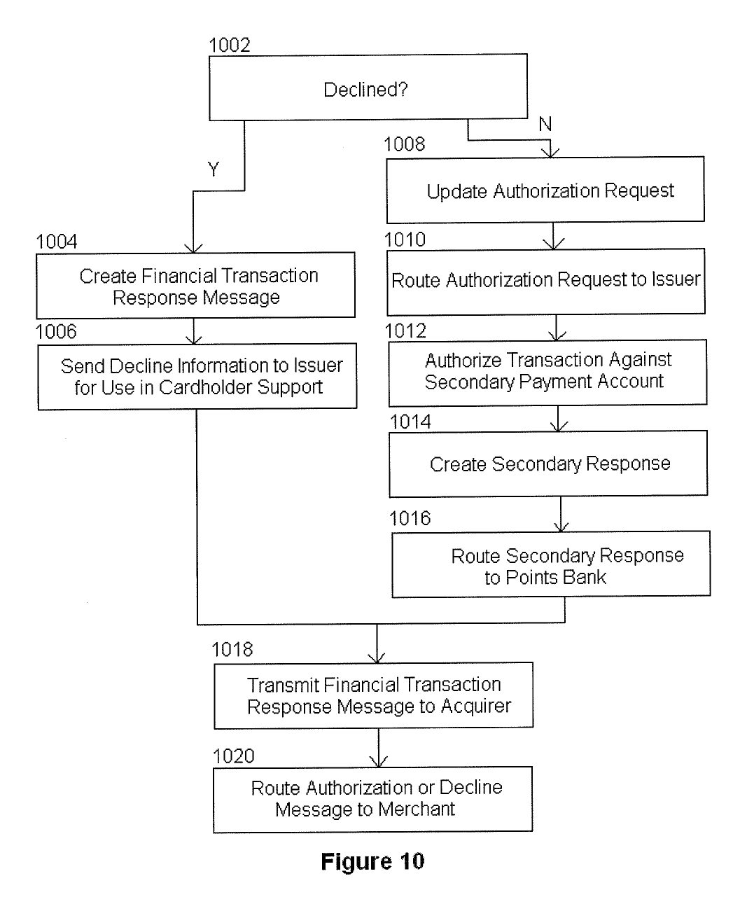

FIG. 10 illustrates the authorization process after the service response has been sent from the rewards system 716 to the authorization system 714. The authorization system 714 determines whether the authorization request has been declined by the rewards system 716 at 1002. If the rewards system 716 declined the transaction, the authorization system 714 creates a financial transaction response message indicating that the transaction has been declined at 1004. A financial transaction response message should indicate whether the requested transaction has been approved or declined. The financial transaction response message may also include the PAN of the redemption card presented to the merchant 704 or otherwise indicated by the cardholder 702. The authorization system 714 transmits decline information to the issuer 710 for use in cardholder support at 1006. Cardholder support may include any services provided by the issuer and/or LPO when a redemption transaction is denied. Alternatively, the authorization system 714 may transmit an indication that the transaction should be declined to the issuer 710, and the issuer 710 may create the financial transaction response message.

If the rewards system 716 has not declined the transaction, the authorization system 714 modifying the financial transaction message with the appropriate information at 1008. The modification may include editing or adding a secondary payment account data field to indicate the secondary payment account selected by the rewards system 716. The modification may also include the starting points balance, the number of points used for the purchase, the remaining points balance, VPP overrides used, and the cash value of the remaining points balance at a particular VPP setting. The authorization system 714 may also initiate the secondary payment transaction against the selected secondary payment account by generating a new message. While the authorization system initiates the secondary payment transaction in the described embodiment, the transaction may also be initiated by another system such as the rewards system processor.

The updated financial transaction message is then routed to the issuer 710 at 1010. While the process is described in relation to the redemption card issuer, the loyalty program funding account and the alternate funding account specified by the cardholder need not be associated with the redemption card issuer. The authorization request may be sent to another issuer associated with either the loyalty program funding account or the alternate funding account specified by the cardholder.

Referring again to FIG. 7, the transaction will be presented for approval against either the loyalty program funding account, such as the LPO's corporate card account, or the alternate funding account at 724. If the LPO's corporate card has been selected and has sufficient available credit to fund the redemption transaction, the transaction is approved and the transaction amount is charged to the LPO's corporate card by the issuer 710. The LPO 712 completes the transaction by reimbursing the issuer 710 through the corporate card account at 726. The reimbursement or settlement may occur in real time. The reimbursement may alternatively occur at any interval by agreement of the issuer 710 and the LPO 712, including periodic intervals or upon the accumulation of a sufficient balance in the account. If the alternate funding account has been selected, the issuer 710 processes the transaction as a regular transaction against that account. The transaction is posted against the cardholder's alternate funding account at 728.

Referring again to FIG. 10, the issuer 710 generates a secondary response at 1014 and routes the secondary response to the authorization system 714 at 1016. The authorization system 714 transmits a financial transaction response message to the acquirer 706 at 1018. The financial transaction response message may be the secondary response, a modified secondary response, or a message generated at the authorization system. The acquirer 706 completes the transaction by routing the financial transaction response message, or at least an indication of whether requested transaction has been approved or denied, to the merchant 704 at 1020. The merchant 704 will notify the cardholder 702.

The issuer may decline the secondary payment transaction if the secondary payment account does not have sufficient funds to fund the transaction. The issuer may also decline the secondary payment transaction for a variety of other reasons. Note that if the issuer 710 declines the redemption transaction which was approved by the rewards system 716, the authorization system 714 must additionally send a message to the rewards system 716 indicating that the transaction amount points equivalent should be added back to the points balance of the loyalty points account if the points for the transaction were previously deducted. Similarly, if a transaction using the alternate funding account as the funding account was denied by the issuer 710, the authorization system 714 may send a message to the rewards system 716 indicating that the usage count should be adjusted.

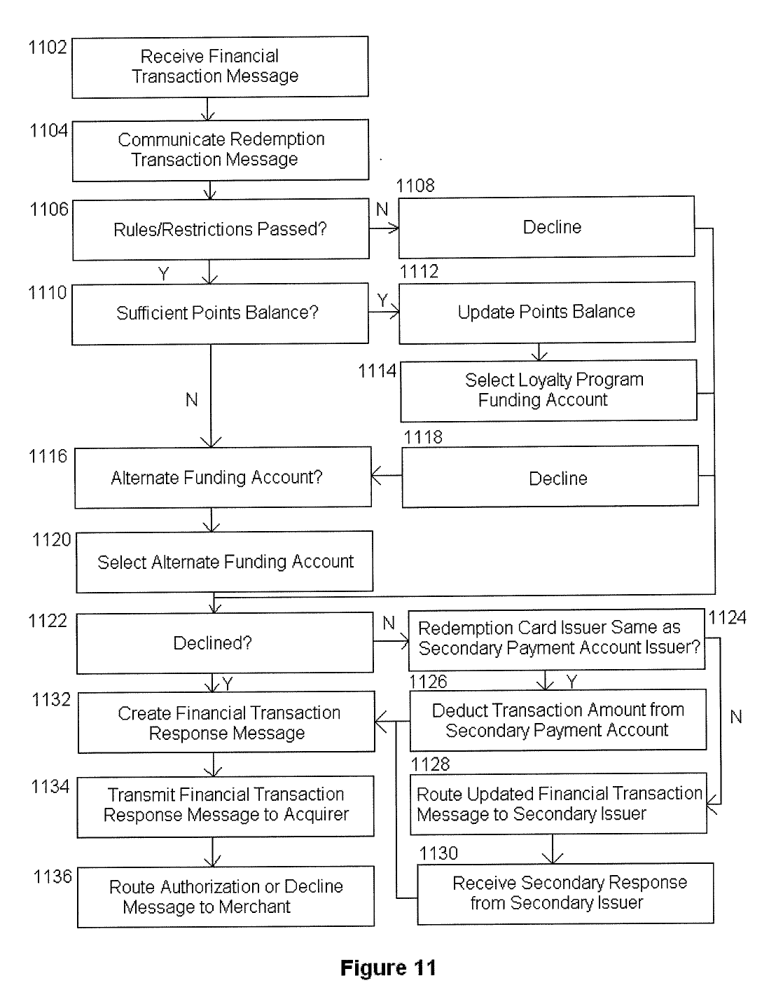

FIG. 11 illustrates the authorization process where the redemption card issuer also provides points bank services (i.e., the redemption card issuer is the points bank operator). From step 1102 to step 1122, the process is similar to the process described in FIGS. 9 and 10. While the Create Service Response 924 and Send Service Response to Authorization System 926 steps are not included in FIG. 11, the redemption card issuer may have to format a request and send it to a different module in order to continue the processing. This step may precede or follow the determination of whether the transaction has been declined at 1122.

If the transaction is approved, the redemption card issuer authorizes the transaction against the secondary payment account. The redemption card issuer determines whether it is the secondary payment account issuer at 1124. The LPO may allow any card or account to be specified as the alternate funding source, so the secondary payment account may be associated with a card issued by the redemption card issuer or a secondary issuer. If the redemption card issuer is the secondary payment account issuer, the transaction amount is applied to the selected secondary payment account (such as the credit line the redemption card issuer has extended to the LPO) at 1126. Generally, this will be accomplished by sending a secondary payment transaction message to the issuer's regular transaction processing system. The transaction processing system will process the transaction as a regular transaction and then send a secondary response to another system at the issuer for further processing in connection with the redemption card program. For example, a routing system may receive the secondary response and transmit the secondary response back to the rewards system processor or to another system, where the secondary response will be used to generate a financial transaction response message. If the secondary issuer is the secondary payment account issuer, the redemption card issuer initiates a secondary payment transaction. The redemption card issuer may update the financial transaction message and route the updated financial transaction message to the secondary issuer at 1128. The redemption card issuer will then receive a secondary response from the secondary issuer indicating whether the transaction has been approved or declined at 1130. Steps 1132 to 1136 are similar to the process described in FIG. 10.

The redemption authorization process may include additional features. For example, the points bank or issuer may send SMS text messages to or otherwise communicate with the cardholder upon the occurrence of predetermined events defined by the cardholder or the LPO. The issuer may send a message to the cardholder if the transaction is denied (e.g., in FIG. 8 at 808). The message may include the reasons for the denial (insufficient points, rules fail) and the current points balance of the cardholder's loyalty points account. The issuer may also send a message to the cardholder if the cardholder's alternate funding account is used to fund the transaction. The message may include the reasons that the redemption card was not approved and any transaction information including, if available, the current balance of the alternate funding account. The issuer may further send a message to the cardholder if the redemption card is authorized. The message may include the transaction amount points equivalent and the updated balance of the cardholder's loyalty points account. The message may be sent by SMS text, email, or any other method.

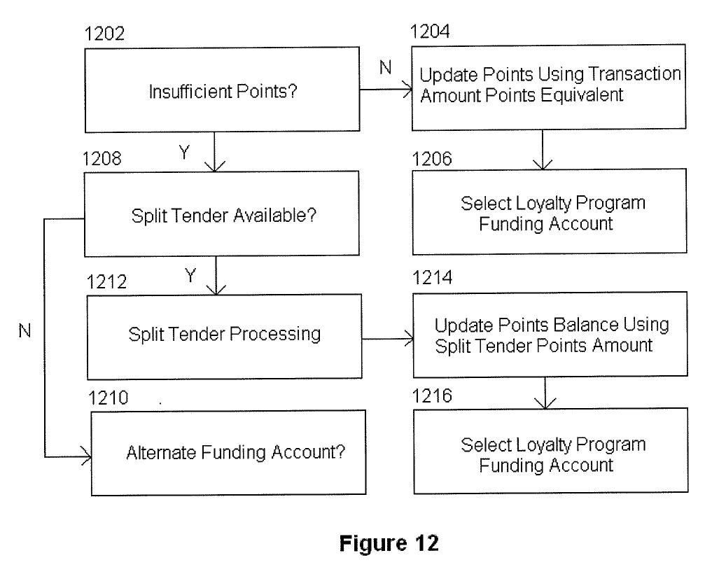

The LPO or issuer may also accept split tender transactions. Referring to FIG. 12, an exemplary embodiment of a split tender transaction is described. The points bank checks whether there are sufficient points in the loyalty points account to cover a redemption transaction at 1202. If the loyalty points account does contain sufficient points, the points bank updates the points balance using the transaction amount points equivalent at 1204 and selects the loyalty program funding account, such as the LPO's corporate card account, at 1206. This is the same process used for regular redemption transactions. However, if the loyalty points account does not contain sufficient points to cover a requested transaction, the points bank does not decline the transaction. Instead, the points bank determines whether the LPO allows split tender transactions at 1208. If the LPO has specified that split tender transactions are not allowed, the points balance determines whether an alternate funding account is available and continues with the process as previously described with reference to FIG. 8.

However, if the LPO does allow split tender transactions, the split tender transaction is processed at 1212. For example, the entire balance of loyalty points may first be deducted from the account and the remaining portion of the transaction amount may be applied to the cardholder's alternative funding account, including an alternative loyalty points account. Alternatively, if the LPO requires points to be deducted in batch units (i.e., only in groups of 50, 100, etc.), appropriate processing is performed to settle the remainder of the transaction using the cardholder's alternate funding account. Regardless of how the split tender transaction is processed, the points bank updates the points balance using the split tender points amount at 1214 and selects the loyalty program funding account, such as the LPO's corporate card account, for the points portion of the split tender transaction at 1216. The split tender points amount is the points equivalent of the points portion of the split tender transaction.

Approved redemption transactions may generate interchange revenue for the issuer. The acquirer may pay the interchange based on the redemption card presented to the merchant rather than the LPO's sponsoring corporate card. This may result is less net interchange revenue for the issuer as compared to the interchange based on the LPO's sponsoring corporate card. The issuer may choose to charge an offline fee to the LPO for offering this service or may factor this revenue deficit into the overall co-branding contract structure with the LPO. If the loyalty program funding account is a prepaid debit card account, there will be no need for the issuer to manage these interchange deficit considerations.

While the transfer of the value of the points has been described in relation to a transaction between the cardholder and a merchant, the process is not limited to such an embodiment. The value of the points may also be transferred in person to person transfers or for person to business payment of bills. In such transfers, the accumulated points would be converted to cash in the same way they are for personal use of points for purchases. The cardholder may transfer the value of the points to any person, business, or entity.

While the authorization process above turns points into a monetary value for the purposes of settling a transaction, the redemption card program may also include other ways of spending points. A redemption card program need not exclude the features of prior art loyalty programs. For example, the LPO may offer pre-existing catalogs with special offers as an alternate option for the redemption of points. Other features of prior art loyalty programs may also be incorporated. Another way loyalty points can be used is in exchange for a discount on a selected item. A merchant may indicate that in exchange for a certain amount of points, the cardholder will receive a discount on an item. If the merchant includes this information in the transaction message sent to the acquirer and then to the points bank, the points bank may deduct this points amount from the loyalty points account associated with the cardholder and charge the discounted rate to the alternate funding account. Notably, in this embodiment, it may not be necessary to convert a transaction amount into an equivalent points value, as the points amount be directly able to be deducted. However, if the redemption card being used is associated with a different loyalty points program than the one operated by the merchant, the LPO may need to convert the points value associated with the transaction into an equivalent number of loyalty points for the loyalty program associated with the redemption card being used. In such a case, conversion tables, similar to those shown in FIG. 3, could be used, but with points to points conversion ratios employed, rather than points to dollars.

A major advantage of the described systems is that they have limited impact on both issuers and acquirers. Even when points are used, the process is transparent to a merchant and its acquirer. They create and receive standard authorization and settlement messages. Likewise, the issuer need not make any changes to their processing systems, because the points bank intercepts the authorization process before it reaches the issuer and selects a secondary payment account associated with the loyalty points account. The issuer receives an authorization request indicating the selected secondary payment account which can be processed normally. If the issuer is also the points bank operator, the issuer need only add an additional system, and does not need to change existing transaction processing systems.

### Balance Inquiry

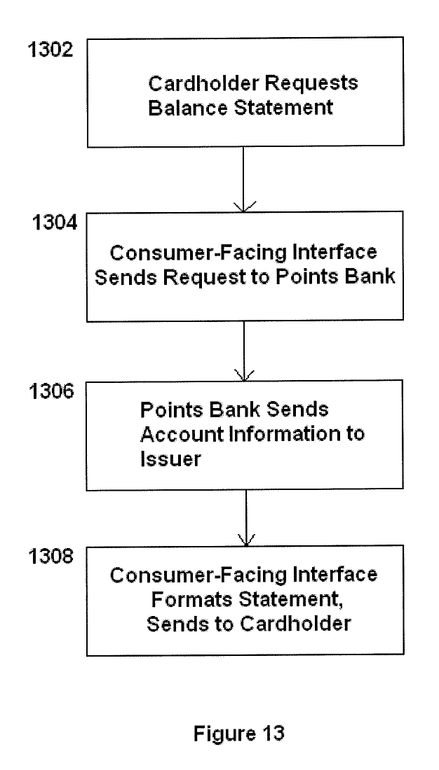

FIG. 13 illustrates one embodiment of the process of obtaining a balance statement. First, a cardholder requests a balance statement in 1302. The cardholder may request the balance statement through a number of channels. The cardholder may request a balance statement online through a website associated with the loyalty program, over the phone (through an 800 number or a VRU or IVR system), by SMS or other text messaging, at an ATM, at a point of sale device, or through any other means.

In 1304, the consumer-facing interface, which may be the issuer, sends a request for the cardholder balance to the points bank. The request should contain some information which can be used to identify the loyalty points account to which the request pertains. This information may be the loyalty points account number, the redemption account number, or any other information which may be used to uniquely identify a cardholder's loyalty points account.

The points bank responds to the request in 1306. The response should contain at least the points balance. The response may also contain the loyalty points account number or other identifying information, the base VPP rate, VPP override levels, and any other information that the issuer requests. The response may also include a base dollar amount and a maximum dollar amount. The base dollar amount is the points balance converted into a cash amount using the base VPP rate. The maximum dollar amount is the points balance converted into a cash amount using the highest VPP rate available to the cardholder, or otherwise identifies the maximum possible dollar value of the cardholder's points. The response may also include a minimum dollar amount. The response may also include any special offers available to the cardholder and the expiration date of any of the points.

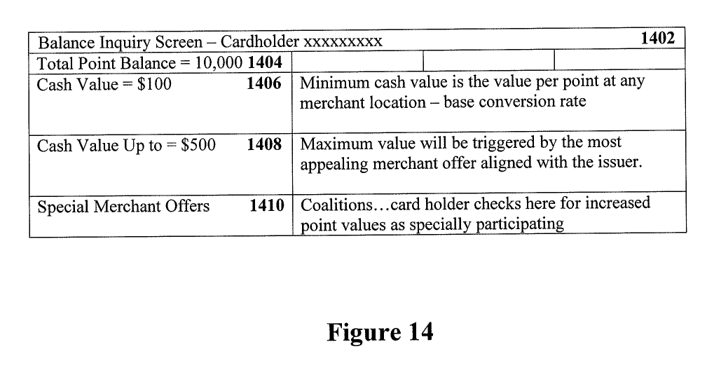

The consumer-facing interface formats the balance statement and sends it to the cardholder in 1308. One embodiment of the balance inquiry screen is illustrated in FIG. 14. Data field 1402 identifies the cardholder. The cardholder may be identified by name or by any other identifying information, such as the cardholder's loyalty points account number or redemption card number. Data field 1404 indicates the points balance in the cardholder's loyalty points account. Data field 1406 indicates the base dollar amount of the points in the cardholder's loyalty points account. Data field 1408 indicates the maximum cash value of the points balance. Data field 1410 presents special merchant offers. The LPO may offer cardholders a better conversion rate at certain merchants for a limited time. Other information may also be displayed, such as the minimum dollar amount of the points or the conditions under which the cardholder may receive the maximum dollar value for the points as identified at 1408. The balance screen may additionally include an ATM value data field for specifying the actual amount of cash one could receive in exchange for the points.

The points balance inquiry may also be initiated with the points bank. The points bank may have online and customer-service call-in channels to receive such requests. Other channels may also be used. For example, a cardholder may present the redemption card to the merchant at the point of sale and request a points balance inquiry. The merchant device will send the request to acquirer, which will send the request to the points bank. The points bank may look up the necessary information (loyalty points account points balance, VPP levels associated with the loyalty points account) and send a response to the acquirer without contacting the issuer. Alternatively, the points bank may send some information, such as a balance inquiry advice message, to the issuer. The acquirer forwards the balance inquiry response to the merchant, and the merchant presents the information to the cardholder in the form of a printed receipt or a visual display at the terminal.

### Returns

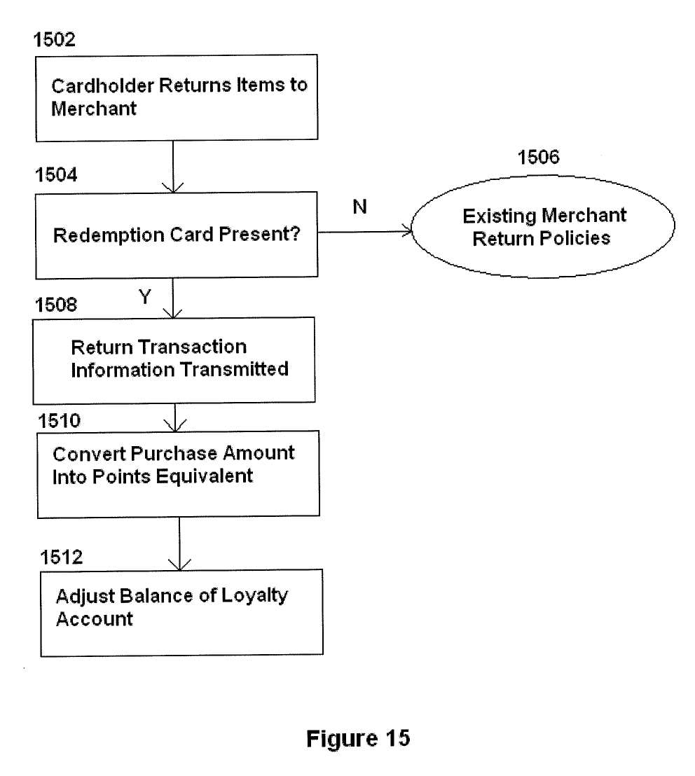

The cardholder may purchase an item and become dissatisfied with it for a number of reasons. If the item was originally purchased as part of a redemption transaction, the loyalty program should be able to process the return. One embodiment of the return process is illustrated in FIG. 15. In FIG. 1502, the cardholder returns the unwanted item to the merchant. The merchant will inquire whether the cardholder has the redemption card in 1504. If the cardholder does not have the redemption card, the redemption card processes are not involved and the merchant will deal with the cardholder's return through existing merchant return policies at 1506. For example, the cardholder may be offered store credit. If the cardholder does have the redemption card, the merchant sends return transaction information to the points bank for processing in 1508. Return transaction information may include the return transaction amount, a sales tax amount, merchant identification information, redemption card information, and any other information.

Once the points bank receives the return transaction information, the points bank converts the return transaction amount into a return transaction points equivalent in 1510. The return transaction points equivalent may be calculated using the same ratios as used in the points redemption process. Alternatively, the return transaction points equivalent may be calculated using a lower points per dollar ratio. Similarly, the points equivalent may be calculated using the pre-tax or post-tax amount. The points bank may also apply a penalty on returns (e.g., a certain number of points are deducted from a cardholder's loyalty points account for each returned item).

Finally, the points bank completes the return transaction by adjusting the points balance of the loyalty points account in 1512. The return transaction also posts to the LPO's corporate card account or other loyalty program funding account. This process may occur regardless of whether the transaction was initially funded by the corporate card account or the alternate funding account. Alternatively, the points bank may scan a transaction database to determine whether the transaction was funded using the loyalty program funding account or the alternate funding account specified by the cardholder. If the original transaction was funded by the alternate funding account, the points bank may indicate that the return should be credited against the alternate funding account and the points balance should not be altered.

The described return process assumes that the loyalty points account has not been closed. If the cardholder closed the loyalty points account before returning the merchandise purchased using the redemption card, a number of options are available. In such a situation, points may not be added to the loyalty points account. The points bank may be configured to not accept return transactions for closed accounts. This may be done through the LPO or issuer setting a rule to that effect. In that case, the merchant may offer a cash equivalent, store credit, or refuse to accept the returned item. Alternatively, the loyalty program may be set up such that the value of returned items for closed accounts is returned to the issuer. The acquirer may send the payment to the issuer, but the points bank will not credit the return amount to the cardholder's loyalty points account.

### Marketing Messages

In addition to receiving text messages or otherwise being contacted during the redemption process, the cardholder may choose to receive (or the LPO or issuer or points bank may choose to send) text messages to the cardholder at other times, including for predetermined events. For example, the points bank may send a text message to indicate that points have been credited to the cardholder's loyalty points account in connection with a points earning transaction or during a return transaction. The points bank may also send alerts when the cardholder hits a milestone (e.g., loyalty points account balance over 10,000 points) or when points expire or are about to expire. The cardholder may also receive text messages sent for promotional or marketing purposes. For example, the cardholder may receive a text message notifying the cardholder that if he/she spends at least $200 at merchant X, he/she will receive 10% of his/her next purchase.

The foregoing merely illustrates the principles of the disclosed subject matter. Various modifications and alterations to the described embodiments will be apparent to those skilled in the art in view of the inventors' teachings herein. Features of existing payment methods and loyalty programs can be seamlessly integrated into the exemplary embodiments of the present invention. It will thus be appreciated that those skilled in the art will be able to devise numerous systems and methods which, although not explicitly shown or described herein, embody the principles of the disclosed subject matter and are thus within its spirit and scope.

What is claimed is:

1. A computer-implemented method for performing a redemption transaction in real-time, the method comprising:
receiving, from an acquirer financial message generation system, a financial transaction message comprising transaction data, said transaction data comprising an account identifier and a transaction amount;
detecting that said account identifier is associated with a redemption card;
communicating a redemption transaction message to a rewards system processor;
identifying by said rewards system processor at least one loyalty points account associated with said redemption card;
determining a loyalty points equivalent to said transaction amount;
querying a database associated with said at least one loyalty points account to determine if the balance of loyalty points associated with said account is at least as large as said loyalty points equivalent and, if the result is that sufficient points are present, deducting said loyalty points equivalent from said at least one loyalty points account;
determining a secondary payment mechanism to settle said redemption transaction;
initiating a secondary payment transaction against said secondary payment mechanism in an amount sufficient to satisfy said transaction amount;
receiving a secondary response to said initiating said secondary payment transaction; and
transmitting a financial transaction response message to said financial transaction message indicating that said financial transaction is authorized, in response to said receiving said secondary response.

2. The method of claim 1, wherein said account identifier comprises a virtual account number communicated to an account-holder prior to initiation of said redemption transaction.

3. The method of claim 1, wherein said secondary payment mechanism comprises a payment card account associated with a payment card network, consisting of one of: a credit card account, a debit card account, a purchasing card, and a prepaid card account; wherein said initiating a secondary payment transaction comprises modifying said financial transaction message by replacing said account identifier in an account number data field of said financial transaction message with an account identifier associated with said payment card account and forwarding said modified financial transaction message to an issuer of said payment card account for further processing.

4. The method of claim 1, wherein said secondary payment mechanism comprises a secondary payment account consisting of one of: a loyalty points account and a line of credit.

5. The method of claim 1, wherein said determining a loyalty points equivalent to said transaction amount comprises converting said transaction amount into a transaction amount points equivalent.

6. The method of claim 5, wherein converting said transaction amount into a transaction amount points equivalent comprises using a base value per point rate to convert said transaction amount into said transaction amount points equivalent.

7. The method of claim 5, wherein converting said transaction amount into a transaction amount points equivalent comprises using an override value per point rate to convert said transaction amount into said transaction amount points equivalent.

8. The method of claim 7, wherein said override value per point rate depends upon cardholder identification information.

9. The method of claim 7, wherein said override value per point rate depends upon said transaction amount.

10. The method of claim 7, wherein said override value per point rate depends upon merchant identification information.

11. The method of claim 7, wherein said override value per point rate depends upon cardholder behavioral information.

12. The method of claim 7, wherein said override value per point rate depends upon cardholder segmentation information.

13. The method of claim 1, wherein said determining a loyalty points equivalent to said transaction amount comprises converting said balance of loyalty points into a points balance cash equivalent.

14. The method of claim 1, wherein said determining a secondary payment mechanism comprises selecting an alternate funding account associated with said account identifier in said financial transaction message if the result of said querying is that insufficient points are present to complete said transaction.

15. The method of claim 1, wherein said determining a secondary payment mechanism comprises selecting a loyalty program funding account associated with said account identifier in said financial transaction message if the result of said querying is that sufficient points are present to complete said transaction.

16. The method of claim 15, wherein said loyalty program funding account comprises a payment card account associated with said account identifier in said financial transaction message.

17. The method of claim 15, further comprising:
receiving purchase data information, said purchase information comprising an amount due to an acquirer;
identifying an issuer associated with said secondary payment mechanism; and
reconciling said amount due to an acquirer from said issuer.

18. The method of claim 1, wherein communicating a redemption transaction message to a rewards system processor comprises forwarding said financial transaction message to said rewards system processor.

19. A points bank apparatus for performing a redemption transaction in real time, the apparatus comprising:
a rewards system processor;
a receiver for receiving, from an acquirer financial message generation system, a financial transaction message comprising transaction data, said transaction data comprising an account identifier and a transaction amount, said receiver further configured to receive a secondary response to the initiation of a secondary payment transaction;
a routing unit, coupled to said receiver and to said rewards system processor, configured to detect that said account identifier is associated with a redemption card and to communicate a redemption transaction message to a rewards system processor;
a database, coupled to said rewards system processor, associated with at least one loyalty points account associated with said redemption card;
and a transmitter, coupled to said routing unit, configured to transmit a financial transaction response message to said financial transaction message indicating that said financial transaction is authorized in response to receiving said secondary response;
wherein said rewards system processor is configured to:
identify said at least one loyalty points account associated with said redemption card;
determine a loyalty points equivalent to said transaction amount;
query said database to determine if the balance of loyalty points associated with said account is at least as large as said loyalty points equivalent and, if the result is that sufficient points are present, deduct said loyalty points equivalent from said at least one loyalty points account;
determine a secondary payment mechanism to settle said redemption transaction; and
initiate said second payment transaction against said secondary payment mechanism in an amount sufficient to satisfy said transaction amount.

20. The apparatus of claim 19, wherein said account identifier comprises a virtual account number communicated to an account-holder prior to the initiation of said redemption transaction.

21. The apparatus of claim 19, wherein said secondary payment mechanism comprises a payment card account associated with a payment card network, consisting of one of: a credit card account, a debit card account, a purchasing card, and a prepaid card account; wherein at least one of said rewards system processor and said routing unit is configured to initiate a secondary payment transaction by modifying said financial transaction message by replacing said account identifier in an account number data field of said financial transaction message with an account identifier associated with said payment card account and forwarding said modified financial transaction message to an issuer of said payment card account for further processing.

22. The apparatus of claim 19, wherein said secondary payment mechanism comprises one of a loyalty points account and a line of credit.

23. The apparatus of claim 15, wherein said rewards system processor is configured to determine a loyalty points equivalent to said transaction amount by converting said transaction amount into a transaction amount points equivalent.

24. The apparatus of claim 23, wherein said rewards system processor is configured to convert said transaction amount into a transaction amount points equivalent using a base value per point rate.

25. The apparatus of claim 23, wherein said rewards system processor is configured to convert said transaction amount into a transaction amount points equivalent using an override value per point rate.

26. The apparatus of claim 25, wherein said override value per point rate depends upon cardholder identification information.

27. The apparatus of claim 25, wherein said override value per point rate depends upon said transaction amount.

28. The apparatus of claim 25, wherein said override value per point rate depends upon merchant identification information.

29. The apparatus of claim 25, wherein said override value per point rate depends upon cardholder segmentation information.

30. The apparatus of claim 25, wherein said override value per point rate depends upon cardholder behavioral information.

31. The apparatus of claim 19, wherein said rewards system processor is configured to determine a loyalty points equivalent to said transaction amount by converting said balance of loyalty points into a points balance cash equivalent.

32. The apparatus of claim 19, wherein said rewards system processor is configured to determine a secondary payment mechanism by selecting an alternate funding account associated with said account identifier in said financial transaction message if the result of said querying is that insufficient points are present to complete said transaction.

33. The apparatus of claim 15, wherein said rewards system processor is configured to determine a secondary payment mechanism by selecting a loyalty program funding account associated with said account identifier in said financial transaction message if the result of said querying is that sufficient points are present to complete the transaction.

34. The apparatus of claim 33, wherein said loyalty program funding account comprises a payment card account associated with the issuer of said account identifier in said financial transaction message.

35. The apparatus of claim 33, further comprising:
a clearing system receiver configured to receive purchase information, said purchase information comprising an amount due to an acquirer; and
a clearing system configured to identify an issuer associated with said secondary payment mechanism and reconcile said amount due to an acquirer from said issuer.

36. The apparatus of claim 19, wherein said rewards processor is configured to communicate a redemption transaction to a rewards system processor by forwarding said financial transaction message to said rewards system processor.
